(19) United States
(12) Patent Application Publication
(10) Pub. No.: US 2023/0230751 A1
(43) Pub. Date: Jul. 20, 2023

(54) COIL COMPONENT

(71) Applicant: SAMSUNG ELECTRO-MECHANICS CO., LTD., Suwon-si (KR)

(72) Inventors: Mi Geum KIM, Suwon-si (KR); Jae Hun KIM, Suwon-si (KR)

(73) Assignee: SAMSUNG ELECTRO-MECHANICS CO., LTD., Suwon-si (KR)

(21) Appl. No.: 17/991,177

(22) Filed: Nov. 21, 2022

(30) Foreign Application Priority Data
Jan. 20, 2022 (KR) 10-2022-0008473

(51) Int. Cl. H01F 27/29; H01F 27/32

(52) U.S. Cl. CPC H01F 27/29; H01F 27/323

(57) ABSTRACT

A coil component includes: a body including a coil unit disposed therein, and having first and second surfaces opposing each other with lead-out portions of the coil unit extending thereto, respectively, and fifth and sixth surfaces connected to the first and second surfaces and opposing each other; a first external electrode, and including a first connection portion covering the first surface of the body and a first pad portion covering the sixth surface of the body, the first pad portion having a smaller width than the first connection portion; a second external electrode, and including a second connection portion covering the second surface of the body and a second pad portion covering the sixth surface of the body, the second pad portion having a smaller width than the second connection portion; and an insulating layer covering the first and second connection portions.

### CROSS-REFERENCE TO RELATED APPLICATION(S)

This application claims the benefit of priority to Korean Patent Application No. 10-2022-0008473 filed on Jan. 20, 2022 in the Korean Intellectual Property Office, the disclosure of which is incorporated herein by reference in its entirety.

### TECHNICAL FIELD

The present disclosure relates to a coil component.

### BACKGROUND

An inductor, a coil component, is a typical passive electronic component used in an electronic device together with a resistor and a capacitor.

As electronic devices are increasingly improved in performance while their sizes become smaller, the number of electronic components used in the electronic devices has increased, and the sizes of the electronic components have decreased.

In accordance with the integration of the electronic components, there has been a demand for a bottom electrode structure in which external electrodes are exposed only to a mounting surface.

### SUMMARY

An aspect of the present disclosure may provide a coil component advantageous in size reduction and integration by exposing external electrodes only to amounting surface of the coil component.

Another aspect of the present disclosure may provide a coil component capable of minimizing a distance thereof from an adjacent coil component by preventing a short-circuit between the adjacent coil components.

According to an aspect of the present disclosure, a coil component may include: a body including a coil unit disposed therein, and having first and second surfaces opposing each other in a first direction with lead-out portions of the coil unit extending thereto, respectively, third and fourth surfaces connected to the first and second surfaces and opposing each other in a second direction, and fifth and sixth surfaces connected to the first to fourth surfaces and opposing each other in a third direction; a first external electrode disposed on the body, connected to the coil unit, and including a first connection portion covering the first surface of the body and a first pad portion covering the sixth surface of the body, the first pad portion having a smaller width than the first connection portion; a second external electrode disposed on the body, connected to the coil unit, and including a second connection portion covering the second surface of the body and a second pad portion covering the sixth surface of the body, the second pad portion having a smaller width than the second connection portion; and an insulating layer covering the first and second connection portions disposed on the first and second surfaces of the body, respectively.

According to another aspect of the present disclosure, a coil component may include: a body including a coil unit disposed therein, and having first and second surfaces opposing each other in a first direction with lead-out portions of the coil unit extending thereto, respectively, third and fourth surfaces connected to the first and second surfaces and opposing each other in a second direction, and fifth and sixth surfaces connected to the first to fourth surfaces and opposing each other in a third direction; a first external electrode disposed on the body, connected to the coil unit, and including a first connection portion covering the first surface of the body and a first pad portion covering the sixth surface of the body; a second external electrode disposed on the body, connected to the coil unit, and including a second connection portion covering the second surface of the body and a second pad portion covering the sixth surface of the body; and an insulating layer covering the first and second connection portions disposed on the first and second surfaces of the body, respectively, in which the first and second pad portions are spaced apart from the third and fourth surfaces of the body.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a schematic perspective view illustrating a coil component according to a first exemplary embodiment in the present disclosure;

FIG. 2 is a bottom view of FIG. 1 when viewed in direction A;

FIG. 3 is a side view of FIG. 1 when viewed in direction B;

FIG. 4 is a cross-sectional view of FIG. 1 taken along line I-I′;

FIG. 5 is a cross-sectional view of FIG. 1 taken along line II-II′;

FIG. 6 is a view illustrating a coil component according to a second exemplary embodiment in the present disclosure, and corresponding to FIG. 2;

FIG. 7 is a view illustrating the coil component according to the second exemplary embodiment in the present disclosure, and corresponding to FIG. 4;

FIG. 8 is a view illustrating a coil component according to a third exemplary embodiment in the present disclosure, corresponding to FIG. 4, and provided with a partially enlarged view thereof;

FIG. 9 is a schematic perspective view illustrating a coil component according to a fourth exemplary embodiment in the present disclosure; and

FIG. 10 is a cross-sectional view of FIG. 9 taken along line III-III′.

### DETAILED DESCRIPTION

Hereinafter, exemplary embodiments in the present disclosure will now be described in detail with reference to the accompanying drawings.

In the drawings, an L direction may be defined as a first direction or a length direction, a W direction may be defined as a second direction or a width direction, and a T direction may be defined as a third direction or a thickness direction.

Various kinds of electronic components may be used in electronic devices, and various kinds of coil components may be appropriately used between these electronic components to remove noise or for other purposes.

That is, in the electronic devices, the coil components maybe used as power inductors, high frequency (HF) inductors, general beads, high frequency (GHz) beads, common mode filters, and the like.

### First Exemplary Embodiment

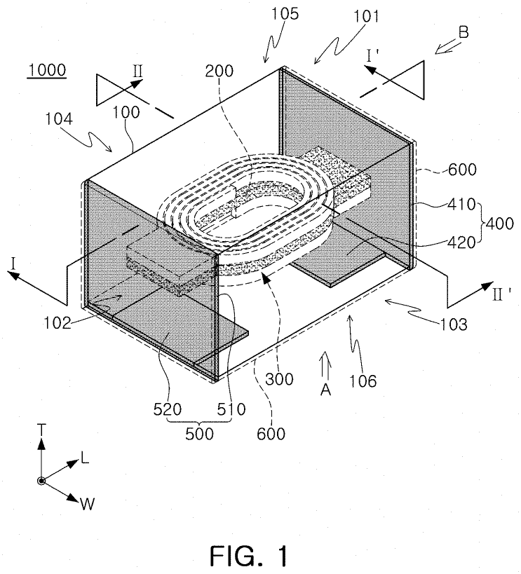

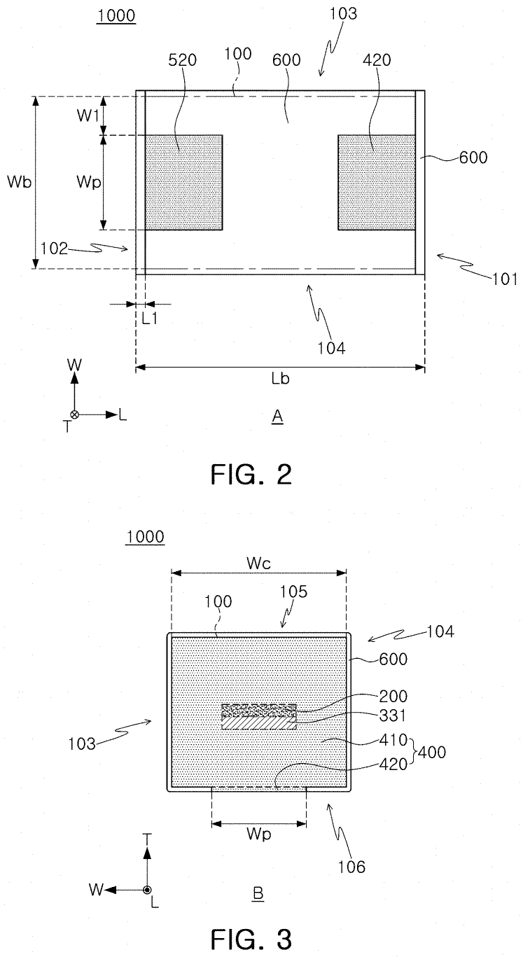

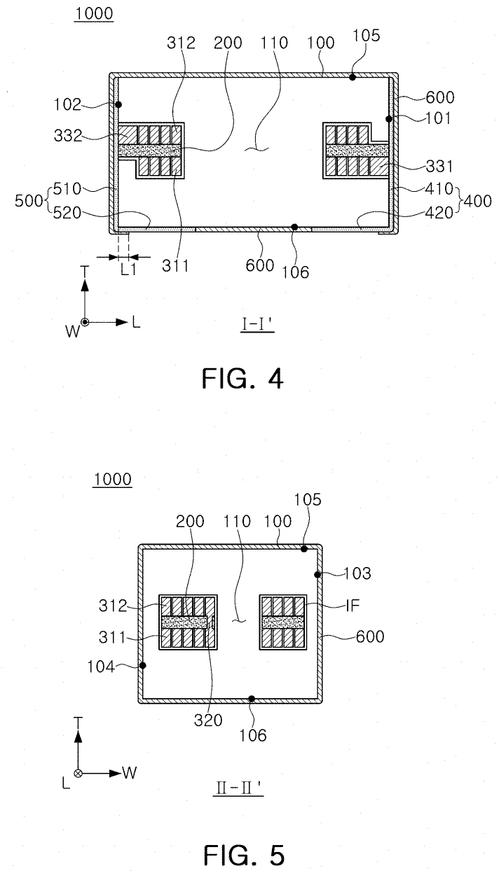

FIG. 1 is a schematic perspective view illustrating a coil component 1000 according to a first exemplary embodiment in the present disclosure. FIG. 2 is a bottom view of FIG. 1 when viewed in direction A. FIG. 3 is a side view of FIG. 1 when viewed in direction B. FIG. 4 is a cross-sectional view of FIG. 1 taken along line I-I′. FIG. 5 is a cross-sectional view of FIG. 1 taken along line II-II′.

Referring to FIGS. 1 through 5, the coil component 1000 according to the first embodiment in the present disclosure may include a body 100, a coil unit 300, external electrodes 400 and 500, and an insulating layer 600, and may further include a substrate 200.

The body 100 may form an appearance of the coil component 1000 according to the present exemplary embodiment, and the coil unit 300 may be embedded in the body 100.

The body 100 may generally have a hexahedral shape.

The first exemplary embodiment in the present disclosure will hereinafter be described on the assumption that the body 100 has a hexahedral shape as an example. However, the description herein does not exclude a coil component including a body formed in a shape other than the hexahedral shape from the scope of the present exemplary embodiment.

Referring to FIGS. 1 through 5, the body 100 may have a first surface 101 and a second surface 102 opposing each other in the length direction L, a third surface 103 and a fourth surface 104 opposing each other in the width direction W, and a fifth surface 105 and a sixth surface 106 opposing each other in the thickness direction T. The first to fourth surfaces 101 to 104 of the body 100 may be wall surfaces of the body 100 that connect the fifth surface 105 and the sixth surface 106 of the body 100 to each other. Hereinafter, opposite end surfaces (one end surface and the other end surface) of the body 100 may refer to the first surface 101 and the second surface 102 of the body 100, respectively, and opposite side surfaces (one side surface and the other side surface) of the body 100 may refer to the third surface 103 and the fourth surface 104 of the body 100, respectively. In addition, one surface and the other surface of the body 100 may refer to the sixth surface 106 and the fifth surface 105 of the body 100, respectively. When the coil component 1000 according to the present exemplary embodiment is mounted on amounting board such as a printed circuit board, the sixth surface 106 of the body 100 may be disposed to face a mounting surface of the mounting board.

The body 100 may be formed so that the coil component 1000 according to the present exemplary embodiment in which the external electrodes 400 and 500 and the insulating layer 600 to be described below are formed, for example, has a length of 2.5 mm, a width of 2.0 mm, and a thickness of 1.0 mm, has a length of 2.0 mm, a width of 1.2 mm, and a thickness of 0.65 mm, has a length of 1.6 mm, a width of 0.8 mm, and a thickness of 0.8 mm, has a length of 1.0 mm, a width of 0.5 mm, and a thickness of 0.5 mm, or has a length of 0.8 mm, a width of 0.4 mm, and a thickness of 0.65 mm, but is not limited thereto. Meanwhile, the above-described exemplary numerical values for the length, width, and thickness of the coil component 1000 refer to numerical values in which process errors are not reflected. Thus, numerical values including process errors in an allowable range may be considered to fall within the above-described exemplary numerical values.

Based on an image of a cross section of the coil component 1000 in the length direction L-thickness direction T taken in a central portion thereof in the width direction W using an optical microscope or a scanning electron microscope (SEM), the above-mentioned length of the coil component 1000 may refer to a maximum value among dimensions of a plurality of line segments spaced apart from each other in the thickness direction T, each connecting two outermost boundary lines opposing each other in the length direction L of the coil component 1000 in parallel to the length direction L in the image. Alternatively, the length of the coil component 1000 may refer to a minimum value among the dimensions of the plurality of line segments described above. Alternatively, the length of the coil component 1000 may refer to an arithmetic mean value of at least three among the dimensions of the plurality of line segments described above. Here, the plurality of line segments parallel to the length direction L may be equally spaced apart from each other in the thickness direction T, but the scope of the present disclosure is not limited thereto.

Based on an image of a cross section of the coil component 1000 in the length direction L-thickness direction T taken in a central portion thereof in the width direction W using an optical microscope or a scanning electron microscope (SEM), the above-mentioned thickness of the coil component 1000 may refer to a maximum value among dimensions of a plurality of line segments spaced apart from each other in the length direction L, each connecting two outermost boundary lines opposing each other in the thickness direction T of the coil component 1000 in parallel to the thickness direction T in the image. Alternatively, the thickness of the coil component 1000 may refer to a minimum value among the dimensions of the plurality of line segments described above. Alternatively, the thickness of the coil component 1000 may refer to an arithmetic mean value of at least three among the dimensions of the plurality of line segments described above. Here, the plurality of line segments parallel to the thickness direction T may be equally spaced apart from each other in the length direction L, but the scope of the present disclosure is not limited thereto.

Based on an image of a cross section of the coil component 1000 in the length direction L-width direction W taken in a central portion thereof in the thickness direction T using an optical microscope or a scanning electron microscope (SEM), the above-mentioned width of the coil component 1000 may refer to a maximum value among dimensions of a plurality of line segments spaced apart from each other in the length direction L, each connecting two outermost boundary lines opposing each other in the width direction W of the coil component 1000 in parallel to the width direction W in the image. Alternatively, the width of the coil component 1000 may refer to a minimum value among the dimensions of the plurality of line segments described above. Alternatively, the width of the coil component 1000 may refer to an arithmetic mean value of at least three among the dimensions of the plurality of line segments described above. Here, the plurality of line segments parallel to the width direction W may be equally spaced apart from each other in the length direction L, but the scope of the present disclosure is not limited thereto.

Alternatively, each of the length, width, and thickness of the coil component 1000 may be measured by a micrometer measurement method. In the micrometer measurement method, each of the length, width, and thickness of the coil component 1000 may be measured by setting a zero point using a micrometer having gage repeatability and reproducibility (R&R), inserting the coil component 1000 according to the present exemplary embodiment between tips of the micrometer, and turning a measurement lever of the micrometer. Meanwhile, concerning the measurement of the length of the coil component 1000 by the micrometer measurement method, the length of the coil component 1000 may refer to a value measured once, or may refer to an arithmetic mean of values measured multiple times. The same may also be applied to the width and the thickness of the coil component 1000.

The body 100 may include a magnetic material and a resin. Specifically, the body 100 maybe formed by stacking one or more magnetic composite sheets in which the magnetic material is dispersed in the resin. However, the body 100 may also have a structure other than the structure in which the magnetic material is dispersed in the resin. For example, the body 100 may be made of a magnetic material such as ferrite, or may be made of a non-magnetic material.

The magnetic material may be ferrite or metal magnetic powder.

The ferrite may be, for example, one or more of spinel type ferrite such as Mg—Zn-based ferrite, Mn—Zn-based ferrite, Mn—Mg-based ferrite, Cu—Zn-based ferrite, Mg—Mn—Sr-based ferrite, or Ni—Zn-based ferrite, hexagonal ferrite such as Ba—Zn-based ferrite, Ba—Mg-based ferrite, Ba—Ni-based ferrite, Ba—Co-based ferrite, or Ba—Ni—Co-based ferrite, garnet type ferrite such as Y-based ferrite, and Li-based ferrite.

The metal magnetic powder may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic powder may be one or more of pure iron powder, Fe—Si-based alloy powder, Fe—Si—Al-based alloy powder, Fe—Ni-based alloy powder, Fe—Ni—Mo-based alloy powder, Fe—Ni—Mo—Cu-based alloy powder, Fe—Co-based alloy powder, Fe—Ni—Co-based alloy powder, Fe—Cr-based alloy powder, Fe—Cr—Si-based alloy powder, Fe—Si—Cu—Nb-based alloy powder, Fe—Ni—Cr-based alloy powder, and Fe—Cr—Al-based alloy powder.

The metal magnetic powder may be amorphous or crystalline. For example, the metal magnetic powder may be Fe—Si—B—Cr-based amorphous alloy powder, but is not necessarily limited thereto.

Each of the ferrite and the metal magnetic powder may have an average particle diameter of about 0.1 μm to 30 μm, but is not limited thereto.

The body 100 may include two or more types of magnetic materials dispersed in the resin. Here, the different types of magnetic materials mean that the magnetic materials dispersed in the resin are distinguished from each other in terms of any one of average particle diameter, composition, crystallinity, and shape.

The resin may include an epoxy, a polyimide, a liquid crystal polymer (LCP), or a mixture thereof, but is not limited thereto.

The body 100 may include a core 110 penetrating through the coil unit 300 to be described below. The core 110 may be formed by filling a through hole of the coil unit 300 with the magnetic composite sheets, but is not limited thereto.

The substrate 200 may be disposed inside the body 100. The substrate 200 may be a component supporting the coil unit 300 to be described below. Side surfaces of the substrate 200 may be exposed to the first and second surfaces 101 and 102 of the body 100 to contact the first and second external electrodes 400 and 500, respectively.

The substrate 200 may be formed of an insulating material including a thermosetting insulating resin such as an epoxy resin, a thermoplastic insulating resin such as a polyimide resin, or a photosensitive insulating resin, or may be formed of an insulating material in which a reinforcing material such as a glass fiber or a filler is impregnated in such an insulating resin. As an example, the substrate 200 may be formed of an insulating material such as prepreg, an Ajinomoto build-up film (ABF), FR-4, a bismaleimide triazine (BT) resin, or a photoimagable dielectric (PID), but is not limited thereto.

The filler may be at least one selected from the group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

When the substrate 200 is formed of an insulating material including a reinforcing material, the substrate 200 may provide more excellent rigidity. When the substrate 200 is formed of an insulating material including no glass fiber, this may be advantageous in decreasing a thickness of the coil component 1000 according to the present exemplary embodiment. In addition, based on the body 100 of the same size, the substrate 200 formed of an insulating material including no glass fiber makes it possible to increase a volume occupied by the coil unit 300 and/or the magnetic metal powder, thereby improving component characteristics. When the substrate 200 is formed of an insulating material including a photosensitive insulating resin, the number of processes for forming the coil unit 300 may decrease, which is advantageous in decreasing a production cost and in forming a fine via 320.

The substrate 200 may have a thickness of, for example, 10 μm or more and 50 μm or less, but is not limited thereto.

The coil unit 300 may be disposed inside the body 100 to exhibit characteristics of the coil component. For example, when the coil component 1000 according to the present exemplary embodiment is utilized as a power inductor, the coil unit 300 may serve to stabilize power of an electronic device by storing an electric field as a magnetic field and maintaining an output voltage.

Referring to FIGS. 4 and 5, the coil unit 300 may include coil patterns 311 and 312, lead-out portions 331 and 332, and a via 320. Specifically, a first coil pattern 311 and a first lead-out portion 331 may be disposed on a lower surface of the substrate 200 opposing the sixth surface 106 of the body 100, and a second coil pattern 312 and a second lead-out portion 332 may be disposed on an upper surface of the substrate 200 opposing the lower surface of the substrate 200. The first coil pattern 311 may be connected in contact with the first lead-out portion 331 on the lower surface of the substrate 200. The second coil pattern 312 may be connected in contact with the second lead-out portion 332 on the upper surface of the substrate 200, and the via 320 may be connected in contact with respective inner ends of the first coil pattern 311 and the second coil pattern 312 by penetrating through the substrate 200. In this way, the coil unit 300 may function as a single coil as a whole.

Each of the first coil pattern 311 and the second coil pattern 312 may have a planar spiral shape in which at least one turn is formed around the core 110. As an example, the first coil pattern 311 may form at least one turn around the core 110 on the lower surface of the substrate 200.

The lead-out portions 331 and 332 may extend to the first and second surfaces 101 and 102 of the body 100, respectively. That is, the first lead-out portion 331 may extend to the first surface 101 of the body 100, and the second lead-out portion 332 may extend to the second surface 102 of the body 100.

At least one of the coil patterns 311 and 312, the via 320, and the lead-out portions 331 and 332 may include at least one metal layer. For example, based on the directions of FIGS. 4 and 5, when the second coil pattern 312, the via 320, and the second lead-out portion 332 are plated on the upper surface of the substrate 200, each of the second coil pattern 312, the via 320, and the second lead-out portion 332 may include a seed layer such as an electroless plating layer and an electrolytic plating layer. Here, the electrolytic plating layer may have a single-layer structure or have a multi-layer structure. The electrolytic plating layer having the multi-layer structure may be formed in a conformal film structure in which one electrolytic plating layer covers another electrolytic plating layer, or may be formed by stacking one electrolytic plating layer on only one surface of another electrolytic plating layer. The seed layer of the second coil pattern 312, the seed layer of the via 320, and the seed layer of the second lead-out portion 332 may be integrally formed, such that no boundaries are formed therebetween, but are not limited thereto. The electrolytic plating layer of the second coil pattern 312, the electrolytic plating layer of the via 320, and the electrolytic plating layer of the second lead-out portion 332 may be integrally formed, such that no boundaries are formed therebetween, but are not limited thereto.

Each of the coil patterns 311 and 312, the via 320, and the lead-out portions 331 and 332 may be formed of a conductive material such as copper (Cu), aluminum (Al), silver (Ag), tin (Sn), gold (Au), nickel (Ni), lead (Pb), titanium (Ti), chromium (Cr), molybdenum (Mo), or an alloy thereof, but is not limited thereto. As an example, the first coil pattern 311 may include a seed layer including copper (Cu) in contact with the substrate 200, and an electrolytic plating layer disposed on the seed layer and including copper (Cu), but the scope of the present disclosure is not limited thereto.

An insulating film IF may be disposed between the coil unit 300 and the body 100 and between the substrate 200 and the body 100.

Referring to FIGS. 4 and 5, the insulating film IF may formed along the surfaces of the substrate 200 on which the first and second coil patterns 311 and 312 and the first and second lead-out portions 331 and 332 are formed, but is not limited thereto. The insulating film IF may be filled between adjacent turns of each of the first and second coil patterns 311 and 312, between the first lead-out portion 331 and the first coil pattern 311, and between the second lead-out portion 332 and the second coil pattern 312 for insulation between coil turns.

The insulating film IF may be provided to insulate the coil unit 300 and the body 100 from each other, and may include a known insulating material such as parylene, but is not limited thereto. As another example, the insulating film IF may include an insulating material such as an epoxy resin rather than parylene. The insulating film IF may be formed by a vapor deposition method, but is not limited thereto. As another example, the insulating film IF may be formed by stacking insulation films for forming the insulating film IF on both surfaces of the substrate 200 on which the coil unit 300 is formed and then curing the insulation films, or may be formed by applying an insulation paste for forming the insulating film IF onto both surfaces of the substrate 200 on which the coil unit 300 is formed and then curing the insulation paste. Meanwhile, the insulating film IF may be omitted in the present exemplary embodiment for the above-described reason. That is, if the body 100 has a sufficient electrical resistance at an operating current and voltage designed for the coil component 1000 according to the present exemplary embodiment, the insulating film IF may be omitted in the present exemplary embodiment.

The external electrodes 400 and 500 may be spaced apart from each other on one surface 106 of the body 100, while each being connected to the coil unit 300. Specifically, in the present exemplary embodiment, the first external electrode 400 may include a first connection portion 410 disposed on the first surface 101 of the body 100 and connected in contact with the first lead-out portion 331, and a first pad portion 420 extending from the first connection portion 410 to the sixth surface 106 of the body 100. The second external electrode 500 may include a second connection portion 510 disposed on the second surface 102 of the body 100 and connected in contact with the second lead-out portion 332, and a second pad portion 520 extending from the second connection portion 510 to the sixth surface 106 of the body 100.

Referring to FIG. 2, the first and second pad portions 420 and 520 may be disposed to be spaced apart from each other on the sixth surface 106 of the body 100. The insulating layer 600 to be described below may be disposed in a region between the first and second pad portions 420 and 520 on the sixth surface 106 of the body 100.

Referring to FIGS. 1 through 3, a width Wp of each of the first and second pad portions 420 and 520 may be smaller than a width Wc of each of the first and second connection portions 410 and 510. In this case, the width Wc of each of the first and second connection portions 410 and 510 may be substantially the same as a width Wb of the body 100, but is not limited thereto. Here, the substantially same width refers to a width including a process error or a positional deviation occurring during a manufacturing process and an error occurring during measurement.

For example, a ratio Wp/Wc of the width Wp of the first pad portion 420 to the width Wc of the first connection portion 410 may be more than 0.5 and less than 1.0, and a ratio Wp/Wc of the width Wp of the second pad portion 520 to the width Wc of the second connection portion 510 may be more than 0.5 and less than 1.0, but such ratios are not limited thereto. When the ratio Wp/Wc of the width Wp of the first pad portion 420 to the width Wc of the first connection portion 410 is less than 0.5, areas of the pad portions 420 and 520 may not be sufficiently secured with respect to the coil component of the same size, resulting in a deterioration in fixing strength of the coil component when mounted.

Here, the width Wp of each of the first and second pad portions 420 and 520 may refer to a size of each of the first and second pad portions 420 and 520 measured along the width direction W of the body 100. For example, based on an image of the coil component 1000 in the length direction L-width direction W captured by an optical microscope or a scanning electron microscope (SEM) at a magnification of 100 times to 1000 times in a direction from the mounting surface of the coil component 1000, that is, the sixth surface 106 of the body 100, to the fifth surface 105 of the body 100, the width Wp of each of the first and second pad portions 420 and 520 may refer to an arithmetic mean value of at least three among dimensions of a plurality of line segments spaced apart from each other in the length direction L, each connecting two outermost boundary lines opposing each other in the width direction W of each of the pad portions 420 and 520 shown in the image in parallel to the width direction W. Here, the plurality of line segments parallel to the width direction W may be equally spaced apart from each other in the length direction L, but the scope of the present disclosure is not limited thereto.

Also, the width Wc of each of the first and second connection portions 410 and 510 may refer to a size of each of the first and second connection portions 410 and 510 measured along the width direction W of the body 100. For example, based on an image of the coil component 1000 in the width direction W-thickness direction T captured by an optical microscope or a scanning electron microscope (SEM) at a magnification of 100 times to 1000 times in a direction toward the first and second surfaces 101 and 102 of the body 100, the width Wc of each of the first and second connection portions 410 and 510 may refer to an arithmetic mean value of at least three among dimensions of a plurality of line segments spaced apart from each other in the thickness direction T, each connecting two outermost boundary lines opposing each other in the width direction W of each of the connection portions 410 and 510 shown in the image in parallel to the width direction W. Here, the plurality of line segments parallel to the width direction W may be equally spaced apart from each other in the thickness direction T, but the scope of the present disclosure is not limited thereto.

Referring to FIG. 2, the first and second pad portions 420 and 520 may have a bottom electrode structure corresponding to a so-called window structure. That is, the first and second pad portions 420 and 520 may be exposed only to the mounting surface, thereby reducing a mounting area. In addition, margins maybe formed by the insulating layer 600 in the length direction L and in the width direction W, thereby reducing a risk of a short circuit between adjacent coil components, which is advantageous in integration.

Referring to FIG. 2, based on the width direction W, a ratio W1/Wb of a distance W1 by which each of the first and second pad portions 420 and 520 is spaced apart from each of the third and fourth surfaces 103 and 104 of the body 100 to the width Wb of the body 100 may be 0.0167 or more and 0.0833 or less.

The distance W1 may be determined depending on a formation position and a size of an opening region that guides the plating of each of the external electrodes 400 and 500, the opening region being formed by forming the insulating layer 600 to be described below on the sixth surface 106 of the body 100 and then partially removing the insulating layer 600.

TABLE 1

| | | | Solder exposure |
|---|---|---|---|
| | Ratio of | Chip | evaluation when |
| | insulation | shifting | coil component is |
| | margin in width | evaluation | mounted |
| Experimental | direction to body | (Satisfied: OK/ | (Satisfied: OK/ |
| example | width (W1/Wb) | Unsatisfied: NG) | Unsatisfied: NG) |
| #1 | 0 | OK | NG |
| #2 | 0.0083 | OK | NG |
| #3 | 0.0167 | OK | OK |
| #4 | 0.0250 | OK | OK |
| #5 | 0.0333 | OK | OK |
| #6 | 0.0500 | OK | OK |
| #7 | 0.0667 | OK | OK |
| #8 | 0.0833 | OK | OK |
| #9 | 0.1000 | NG | OK |

Referring to Table 1 and FIG. 2, the insulation margin W1 in the width direction may refer to a distance W1 by which each of the pad portions 420 and 520 is spaced apart from each of the third surface 103 and the fourth surface 104 of the body 100 in the width direction W. The chip shifting evaluation is for evaluating a defect regarding whether a coil component deviates from its correct position after the coil component is mounted on a printed circuit board, and the defect may occur when the pad portions 420 and 520 are small in size. The solder exposure evaluation when the coil component is mounted is for evaluating a defect regarding whether a solder on the mounting surface deviates from an outermost side region of the coil component, and the defect may occur when the insulation margins around the pad portions 420 and 520 are small.

As a result of the experiments, each being performed by adjusting a distance W1 by which each of the pad portions 420 and 520 is spaced apart from each of the third and fourth surfaces 103 and 104 of the body 100 in the width direction W, the solder exposure defect occurred when the coil component was mounted in Experimental Examples #1 and #2, in which the ratio W1/Wb of the insulation margin of each of the pad portions 420 and 520 in the width direction, that is, the distance W1, to the width Wb of the body 100 was less than 0.0167. In addition, the chip shifting defect was found in Experimental Example #9, in which the ratio W1/Wb of the insulation margin W1 of each of the pad portions 420 and 520 in the width direction to the width Wb of the body 100 was more than 0.0833.

Therefore, when the ratio W1/Wb of the insulation margin W1 of each of the pad portions 420 and 520 in the width direction to the width Wb of the body 100 is 0.0167 or more and 0.0833 or less, the coil component 1000 can be provided with no chip shifting defect while no solder is exposed when the coil component 1000 is mounted.

Meanwhile, as illustrated in FIG. 2, the insulating layer 600 may extend to the third and fourth surfaces 103 and 104 of the body 100. In this case, the insulation margin W1 may be calculated by excluding a thickness of the insulating layer 600 on each of the third and fourth surfaces 103 and 104 of the body 100 from a distance between each of the pad portions 420 and 520 and each of the third and fourth surfaces 103 and 104 of the body 100 in the width direction W in the above-described SEM image in a direction toward the mounting surface. Alternatively, based on an SEM image of a cross section of the coil component in the width direction W-thickness direction T captured to include the pad portions 420 and 520, the insulation margin W1 may refer to an arithmetic mean value of at least three among dimensions of a plurality of line segments spaced apart from each other in the thickness direction T, each connecting an outermost boundary line of each of the pad portions 420 and 520 and an outermost boundary line of the third surface 103 of the body 100 opposing each other in the width direction W in parallel to the width direction W in the image. Here, the plurality of line segments parallel to the width direction W may be equally spaced apart from each other in the thickness direction T, but the scope of the present disclosure is not limited thereto.

Referring to FIG. 2 which is a bottom view of FIG. 1, a ratio L1/Lb of a distance L1 by which each exposed portion of the pad portions 420 and 520 is spaced apart from each of the first and second surfaces 101 and 102 of the body 100 in the length direction L to a length Lb of the body 100 may be 0.01 or more and 0.04 or less. The distance L1 maybe determined depending on a length of a region in which the insulating layer 600 covering the first and second connection portions 410 and 510 disposed on the first and second surfaces 101 and 102 of the body 100, respectively, extends to the six surface 106 of the body 100 to further cover some of each of the pad portions 420 and 520.

Therefore, based on the length direction L, the ratio L1/Lb of the length L1 of the insulating layer 600 extending to the sixth surface 106 of the body 100 to the length of the body 100 may be 0.01 or more and 0.04 or less.

TABLE 2

| | | | Solder exposure |
|---|---|---|---|
| | Ratio of | Chip | evaluation when |
| | insulation | shifting | coil component is |
| | margin in length | evaluation | mounted |
| Experimental | direction to body | (Satisfied: OK/ | (Satisfied: OK/ |
| example | length (L1/Lb) | Unsatisfied: NG) | Unsatisfied: NG) |
| #1 | 0 | OK | NG |
| #2 | 0.005 | OK | NG |
| #3 | 0.010 | OK | OK |
| #4 | 0.015 | OK | OK |
| #5 | 0.020 | OK | OK |
| #6 | 0.030 | OK | OK |
| #7 | 0.040 | OK | OK |
| #8 | 0.050 | NG | OK |
| #9 | 0.060 | NG | OK |

Referring to Table 2 and FIG. 2, the insulation margin L1 in the length direction may refer to a length of a region in which the insulating layer 600 covering the first and second connection portions 410 and 510 disposed on the first and second surfaces 101 and 102 of the body 100, respectively, extends to the six surface 106 of the body 100 to further cover some of each of the pad portions 420 and 520.

As a result of the experiments, each being performed by adjusting a length L1 of a region in which the insulating layer 600 extends to the six surface 106 of the body 100 to cover some of each of the pad portions 420 and 520, the solder exposure defect occurred when the coil component was mounted in Experimental Examples #1 and #2, in which the ratio L1/Lb of the insulation margin of each of the pad portions 420 and 520 in the length direction, that is, the extending length L1 of the insulating layer 600, to the length Lb of the body 100 was less than 0.01. In addition, the chip shifting defect was found in Experimental Examples #8 and #9, in which the ratio L1/Lb of the insulation margin of each of the pad portions 420 and 520 in the length direction, that is, the extending length L1 of the insulating layer 600, to the length Lb of the body 100 was more than 0.04.

Therefore, the ratio L1/Lb of the insulation margin of each of the pad portions 420 and 520 in the length direction, that is, the extending length L1 of the insulating layer 600, to the length Lb of the body 100 is 0.01 or more and 0.04 or less, the coil component 1000 can be provided with no chip shifting defect while no solder is exposed when the coil component 1000 is mounted.

Meanwhile, as illustrated in FIG. 2, for example, based on an image of the coil component 1000 in the length direction L-width direction W captured by an optical microscope or a scanning electron microscope (SEM) at a magnification of 100 times to 1000 times in a direction from the mounting surface of the coil component 1000, that is, the sixth surface 106 of the body 100, to the fifth surface 105 of the body 100, the length L1 of the region in which the insulating layer 600 extends to the six surface 106 of the body 100 to cover some of each of the pad portions 420 and 520 may refer to an arithmetic mean value of at least three among dimensions of a plurality of line segments spaced apart from each other in the width direction W, each connecting an outermost boundary line of each of the pad portions 420 and 520 and an outermost boundary line of the coil component 1000 opposing each other in the length direction L in parallel to the length direction L in the image. Here, the plurality of line segments parallel to the length direction L may be equally spaced apart from each other in the width direction W, but the scope of the present disclosure is not limited thereto.

Referring to FIG. 3, the width Wc of each of the first and second connection portions 410 and 510 maybe substantially the same as the width Wb of each of the first and second surfaces 101 and 102 of the body 100. Here, the substantially same width refers to a width including a process error or a positional deviation occurring during a manufacturing process and an error occurring during measurement.

The first and second connection portions 410 and 510 may cover the first and second surfaces 101 and 102 of the body 100, respectively. For example, the first and second connection portions 410 and 510 may be disposed on the entire first and second surfaces 101 and 102 of the body 100, respectively, but are not limited thereto.

An increase in area of the first and second connection portions 410 and 510 may improve reliability in connection between the first and second connection portions 410 and 510 with the lead-out portions 331 and 332, and may also improve Rdc characteristics.

Meanwhile, when the pad portions 420 and 520 have insulation margins in the width direction W and in the length direction L as described above, areas of the pad portions 420 and 520 exposed to the mounting surface may decrease, resulting in a deterioration in fixing strength the coil component when mounted.

In the coil component 1000 according to the present exemplary embodiment, when each of the insulation margins of the pad portions 420 and 520 in the width direction W and in the length direction L is formed at a largest value of the above-described range, a ratio of the exposed areas of the pad portions 420 and 520 to an area of the mounting surface of the body 100 may be approximately 0.30.

Referring to Table 3 below, it was confirmed that, even in a case where the ratio of the exposed areas of the pad portions 420 and 520 to the area of the mounting surface of the body 100 was approximately 0.30, the fixing strength exceeding a reference value (10N) was secured.

TABLE 3

| | Ratio of | | |
|---|---|---|---|
| | exposed area | | Whether to |
| | of pad portions | Fixing | satisfy |
| Experimental | to area of mounting | strength | reference |
| example | surface of body | (N) | value |
| #1 | 0.60 | 32 | OK |
| #2 | 0.45 | 27 | OK |
| #3 | 0.30 | 23 | OK |

The external electrodes 400 and 500 may be formed on the surfaces of the body 100 by performing electrolytic plating using the insulating layer 600 formed on the surfaces of the body 100, which will be described below, as a plating resist. When the body 100 includes magnetic metal powder, the magnetic metal powder may be exposed to the surfaces of the body 100. The magnetic metal powder exposed to the surfaces of the body 100 may impart conductivity to the surfaces of the body 100 during electrolytic plating, and the external electrodes 400 and 500 may be formed on the surfaces of the body 100 by electrolytic plating.

The connecting portions 410 and 510 and the pad portions 420 and 520 of the external electrodes 400 and 500 maybe formed by the same plating process, such that no boundaries are formed therebetween. That is, the first connection portion 410 and the first pad portion 420 may be integrally formed with each other, and the second connection portion 510 and the second pad portion 520 may be integrally formed with each other. In addition, the connecting portions 410 and 510 and the pad portions 420 and 520 may be made of the same metal. However, the description herein does not exclude, from the scope of the present disclosure, a case in which the connection portions 410 and 510 and the pad portions 420 and 520 are formed by different plating processes and boundaries are formed therebetween.

The external electrodes 400 and 500 may be formed of a conductive material such as copper (Cu), aluminum (Al), silver (Ag), tin (Sn), gold (Au), nickel (Ni), lead (Pb), titanium (Ti), or an alloy thereof, but are not limited thereto.

Each of the external electrodes 400 and 500 maybe formed as a plurality of layers. For example, each of the external electrodes 400 and 500 may have a layered structure including a metal layer including copper (Cu), a metal layer including nickel (Ni), and a metal layer 13 including tin (Sn).

The external electrodes 400 and 500 may be formed by coating a conductive paste including conductive powder including at least one of copper, silver, and tin and a thermosetting resin, and then curing the conductive paste. Alternatively, the external electrodes 400 and 500 maybe formed by a plating method, a vapor deposition method such as sputtering, or the like.

The insulating layer 600 may electrically protect the coil component, reduce a leakage current, and function as a plating resist at the time of forming the external electrodes 400 and 500 by plating.

Referring to FIGS. 1 through 5, the insulating layer 600 may be disposed on the surfaces of the body 100.

Referring to FIG. 4, the insulating layer 600 may cover the first and second connection portions 410 and 510 disposed on the first and second surfaces 101 and 102 of the body 100, respectively. By covering the first and second connection portions 410 and 510, the insulating layer 600 may prevent the coil component 1000 according to the present exemplary embodiment from being short-circuited with another electronic component mounted adjacent thereto when the coil component 1000 is mounted on amounting board such as a printed circuit board. In addition, the first and second external electrodes 400 and 500 may be exposed only to the mounting surface, thereby reducing a mounting area based on the coil component 1000 of the same size.

The insulating layer 600 may extend to cover the third surface 103 and the fourth surface 104 of the body 100. Also, the insulating layer 600 may extend to cover the fifth surface 105 of the body 100. In addition, the insulating layer 600 may extend to the sixth surface 106 of the body 100 to cover some of each of the first and second pad portions 420 and 520.

That is, the insulating layer 600 may cover the third to sixth surfaces 103 to 106 of the body 100, except for areas where the first and second external electrodes 400 and 500 are disposed, and may additionally cover an outer surface of each of the first and second connection portions 410 and 510 and some of each of the first and second pad portions 420 and 520. As a result, only all or some of each of the first and second pad portions 420 and 520 of the external electrodes 400 and 500 of the coil component 1000 according to the present exemplary embodiment may be exposed to the mounting surface.

The insulating layer 600 may function as a plating resist at the time of forming at least some of each of the external electrodes 400 and 500 by plating, but is not limited thereto. For example, when the external electrodes 400 and 500 are formed by plating, the insulating layer 600 may be disposed on the sixth surface 106 of the body 100 first, and then openings may be formed by removing the insulating layer 600 in areas where the pad portions 420 and 520 are to be formed.

The insulating layer 600 may be integrally formed on the surfaces of the body 100, or boundaries of the insulating layer 600 may be formed between the surfaces of the body 100. As a non-limiting example, insulating layers 600 formed on the fifth and sixth surfaces 105 and 106 of the body 100 and insulating layers 600 formed on the third and fourth surfaces 103 and 104 of the body 100 may be formed in different processes, and thus, boundaries may be formed therebetween.

The insulating layer 600 may include a thermoplastic resin such as polystyrene, vinyl acetate, polyester, polyethylene, polypropylene, polyamide, rubber, or acryl, a thermosetting resin such as phenol, epoxy, urethane, melamine, or alkyd, a photosensitive resin, parylene, SiOₓ, or SiNₓ.

The insulating layer 600 may have an adhesive function. For example, when the insulating layer 600 is formed by stacking an insulation film on the body 100, the insulation film may include an adhesive ingredient to adhere to surfaces of the body 100. In this case, an adhesive layer may be separately formed on one surface of the insulating layer 600 that contacts the body 100. However, a separate adhesive layer may not be formed on one surface of the insulating layer 600, for example, in a case where the insulating layer 600 is formed using an insulation film in a semi-cured (B-stage) state.

The insulating layer 600 may be formed by applying a liquid-phase insulating resin onto the surfaces of the body 100, applying an insulating paste onto the surfaces of the body 100, stacking an insulation film on the surfaces of the body 100, or forming an insulating resin on the surfaces of the body 100 by vapor deposition. The insulation film may be a dry film (DF) including a photosensitive insulating resin, an Ajinomoto build-up film (ABF) including no photosensitive insulating resin, a polyimide film, or the like.

The insulating layer 600 may be formed in a thickness range of 10 nm to 100 μm, but is not limited thereto. When the thickness of the insulating layer 600 is less than 10 nm, the characteristics of the coil component may decrease, such as a decrease in Q factor, a decrease in breakdown voltage, and a decrease in self-resonant frequency (SRF). When the thickness of the insulating layer 600 is more than 100 μm, an entire length, width, and thickness of the coil component may increase, which is disadvantageous in reducing the thickness of the coil component.

Here, based on an image of a cross section of the coil component 1000 in the length direction L-thickness direction T taken in a central portion thereof in the width direction W using an optical microscope or a scanning electron microscope (SEM), the thickness of the insulating layer 600 may refer to an arithmetic mean value of at least three among dimensions of a plurality of line segments spaced apart from each other in the thickness direction T, each connecting outermost boundary lines opposing each other in the length direction L of the insulating layer 600 in parallel to the length direction L in the image. Here, the plurality of line segments parallel to the length direction L may be equally spaced apart from each other in the thickness direction T, but the scope of the present disclosure is not limited thereto.

### Second Exemplary Embodiment

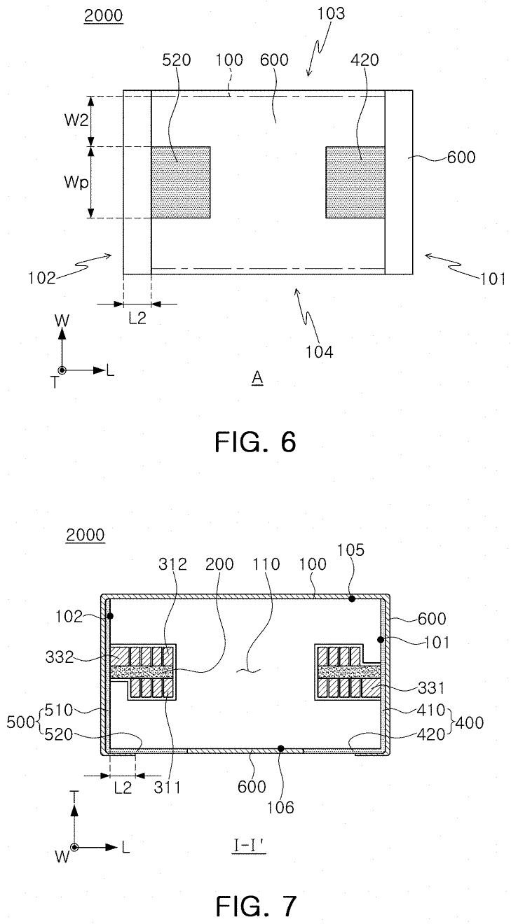

FIG. 6 is a view illustrating a coil component 2000 according to a second exemplary embodiment in the present disclosure, and corresponding to FIG. 2. FIG. 7 is a view illustrating the coil component 2000 according to the second exemplary embodiment in the present disclosure, and corresponding to FIG. 4.

Upon comparing FIGS. 6 and 7 with FIGS. 2 and 4, the coil component 2000 according to the present exemplary embodiment is different from the coil component 1000 according to the first exemplary embodiment in the present disclosure in regions where pad portions 420 and 520 are formed through openings of the insulating layer 600 on the sixth surface 106 of the body 100, and regions where the pad portions 420 and 520 are partially covered by the insulating layer 600. Thus, in describing the coil component 2000 according to the present exemplary embodiment, only the exposed regions of the pad portions 420 and 520, which are different from those in the first exemplary embodiment in the present disclosure, will be described. Concerning the other configuration of the present exemplary embodiment, what has been described above for the first exemplary embodiment in the present disclosure may be identically applied thereto.

Referring to FIG. 6, a distance W2 by which each of the pad portions 420 and 520 is spaced apart from each of the third and fourth surfaces 103 and 104 of the body 100 in the width direction Win the coil component 2000 according to the present exemplary embodiment maybe larger than the distance W1 by which each of the pad portions 420 and 520 is spaced apart from each of the third and fourth surfaces 103 and 104 of the body 100 in the width direction W in the coil component 1000 according to the first exemplary embodiment. This may be a structure obtained by reducing the width Wp of the opening of the insulating layer 600 serving as a plating resist at the time of forming each of the first and second pad portions 420 and 520.

Referring to FIGS. 6 and 7, a length L2 of a region in which the insulating layer 600 extends to the six surface 106 of the body 100 to cover some of each of the pad portions 420 and 520 in the coil component 2000 according to the present exemplary embodiment may be larger than the length L1 of the region in which the insulating layer 600 extends to the six surface 106 of the body 100 to cover some of each of the pad portions 420 and 520 in the coil component 1000 according to the first exemplary embodiment. That is, an insulation margin of each of the pad portions 420 and 520 in the length direction L may increase.

As compared with the coil component 1000 according to the first exemplary embodiment, the coil component 2000 according to the present exemplary embodiment may be more advantageous in that, by increasing the insulation margins around the pad portions 420 and 520, the short-circuit prevention effect between adjacent coil components when mounted can be improved, thereby further increasing a degree of integration of the coil components when mounted.

However, the decrease in exposed area of the pad portions 420 and 520 may deteriorate the fixing strength of the coil component when mounted. Therefore, the exposed areas of the pad portions 420 and 520 in the coil component 2000 according to the present exemplary embodiment may be preferably 50% or more of exposed areas of pad portions 420 and 520 when no insulation margins are formed around the pad portions 420 and 520.

### Third Exemplary Embodiment

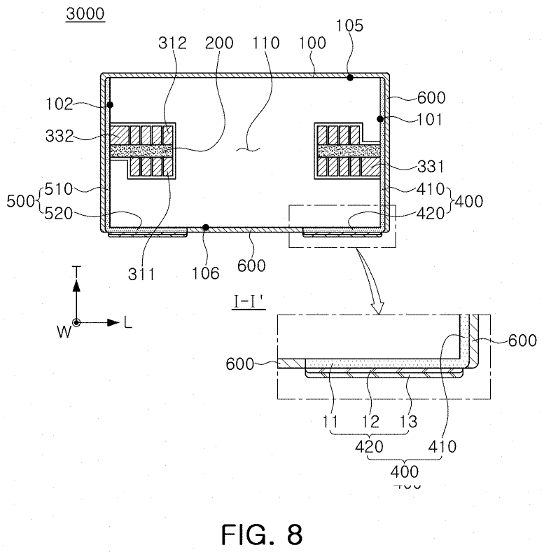

FIG. 8 is a view illustrating a coil component 3000 according to a third exemplary embodiment in the present disclosure, corresponding to FIG. 4, and provided with a partial enlarged view thereof.

Upon comparing FIG. 8 with FIG. 4, the coil component 3000 according to the present exemplary embodiment is different from the coil component 1000 according to the first exemplary embodiment in the present disclosure in the configuration of the pad portions 420 and 520. Thus, in describing the coil component 3000 according to the present exemplary embodiment, only a layered structure of each of the pad portions 420 and 520, which is different from that in the first exemplary embodiment in the present disclosure, will be described. Concerning the other configuration of the present exemplary embodiment, what has been described above for the first exemplary embodiment in the present disclosure may be identically applied thereto.

Referring to FIG. 8, each of the external electrodes 400 and 500 in the coil component 3000 according to the present exemplary embodiment may be formed as a plurality of layers. For example, the first external electrode 400 may include a first metal layer 11, a second metal layer 12 disposed on the first metal layer 11, and a third metal layer 13 disposed on the second metal layer 12, and the first connection portion 410 and the first pad portion 420 described above may refer to the first metal layer 11. Thus, the second and third metal layers 12 and 13 may be disposed only on the first pad portion 420 and may not extend to the first connection portion 410. However, the scope of the present exemplary embodiment is not limited thereto.

Meanwhile, the first metal layer 11 may be integrally disposed on the first surface 101, the second surface 102, and the sixth surface 106 of the body 100. Specifically, the first metal layer 11 of the first external electrode 400 may be disposed on the first surface 101 of the body 100 and extend along the sixth surface 106. Also, the first metal layer 11 of the second external electrode 500 may be disposed on the second surface 102 of the body 100 and extend along the sixth surface 106.

Referring to FIG. 8, each of the pad portions 420 and 520 may include a first metal layer 11 containing copper (Cu), a second metal layer 12 disposed on the first metal layer 11 and containing nickel (Ni), and a third metal layer 13 disposed on the second metal layer 12 and containing tin (Sn).

In the coil component 3000 according to the present exemplary embodiment, after the first metal layer 11 is disposed, the first metal layer 11 in each of the connection portions 410 and 510 may be covered by the insulating layer 600, and then the second and third metal layers 12 and 13 may additionally be disposed on the first layer 11.

### Fourth Exemplary Embodiment

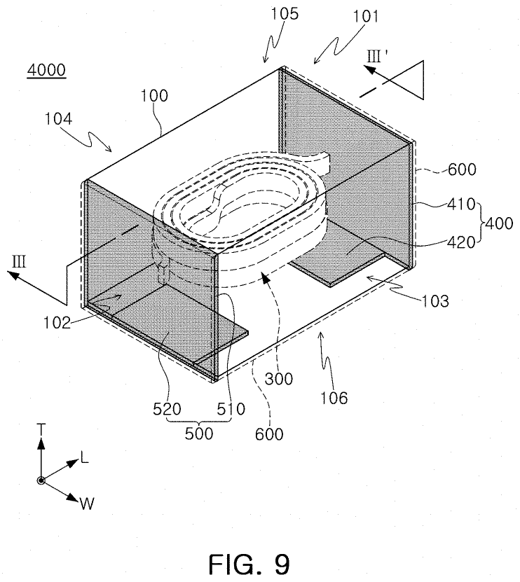

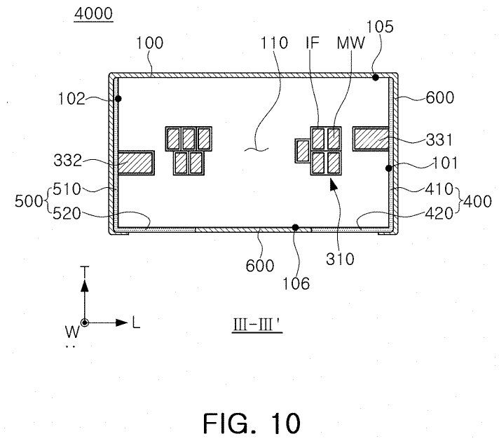

FIG. 9 is a schematic perspective view illustrating a coil component 4000 according to a fourth exemplary embodiment in the present disclosure. FIG. 10 is a cross-sectional view of FIG. 9 taken along line

Upon comparing FIGS. 9 and 10 with FIGS. 1 and 4, the coil component 4000 according to the present exemplary embodiment is different from the coil component 1000 according to the first exemplary embodiment in the present disclosure in the configuration of the coil unit 300 because the substrate 200 is omitted. Thus, in describing the coil component 4000 according to the present exemplary embodiment, only the coil unit 300, which is different from that in the first exemplary embodiment in the present disclosure, will be described. Concerning the other configuration of the present exemplary embodiment, what has been described above for the first exemplary embodiment in the present disclosure may be identically applied thereto.

Referring to FIGS. 9 and 10, the coil unit 300 may be a wire-wound type coil formed by winding a wire material in a spiral shape, the wire material including a metal wire MW such as a copper wire and an insulating film IF coating a surface of the metal wire MW.

The coil unit 300 may include a wound portion 310 forming at least one turn around the core 110, and lead-out portions 331 and 332 extending from opposite ends of the wound portion 310, respectively, to extend to the first and second surfaces 101 and 102 the body 100, respectively.

The first lead-out portion 331 may extend from one end of the wound portion 310 to extend to the first surface 101 of the body 100, and the second lead-out portion 332 may extend from the other end of the wound portion 310 to extend to the second surface 102 of the body 100.

The wound portion 310 may be formed by winding the above-described wire material in the spiral shape. Referring to FIG. 10, in a cross section of the coil component 4000 according to the present exemplary embodiment in the length direction L-thickness direction T, a surface of each turn of the wound portion 310 may be coated with the insulating film IF. The wound portion 310 may be formed in one or more layers. Each of the layers in the wound portion 310 may be formed in a planar spiral shape, and may be wound with at least one turn.

The lead-out portions 331 and 332 may be integrally formed with the wound portion 310. For example, the wound portion 310 may be formed by winding the above-described wire material, and the lead-out portions 331 and 332 may be regions in which the wire material extends from the wound portion 310.

The metal wire MW may be formed of a conductive material such as copper (Cu), aluminum (Al), silver (Ag), tin (Sn), gold (Au), nickel (Ni), lead (Pb), titanium (Ti), chromium (Cr), molybdenum (Mo), or an alloy thereof, but is not limited thereto.

The insulating film IF may include an insulating material such as enamel, paralin, epoxy, or polyimide. The insulating film IF may be formed in two or more layers. As a non-limiting example, the insulating film IF may include a coating layer contacting the metal wire MW, and a fusion layer formed on the coating layer. The fusion layer constituting a turn of the metal wire MW as a wire material after being wound in a coil shape may be joined to the fusion layer constituting an adjacent turn of the metal wire MW by heat and pressure. When the metal wire MW including the insulating film IF is wound in such a structure, fusion layers of a plurality of turns in the wound portion 310 may be fused to and integrally formed with each other.

Meanwhile, although it is illustrated in FIGS. 9 and 10 that the coil unit 300 of the present exemplary embodiment is wound in an alpha type, the scope of the present exemplary embodiment is not limited thereto, and the coil unit 300 may be wound in an edge-wise type.

As set forth above, according to the exemplary embodiments in the present disclosure, it is possible to provide a coil component advantageous in size reduction and integration by exposing external electrodes only to a mounting surface of the coil component.

In addition, according to the exemplary embodiments in the present disclosure, it is possible to provide a coil component capable of minimizing a distance thereof from an adjacent coil component by preventing a short-circuit between the adjacent coil components.

While exemplary embodiments have been shown and described above, it will be apparent to those skilled in the art that modifications and variations could be made without departing from the scope of the present invention as defined by the appended claims.

What is claimed is:

1. A coil component comprising:
a body including a coil unit disposed therein, and having first and second surfaces opposing each other in a first direction with lead-out portions of the coil unit extending thereto, respectively, third and fourth surfaces connected to the first and second surfaces and opposing each other in a second direction, and fifth and sixth surfaces connected to the first to fourth surfaces and opposing each other in a third direction;
a first external electrode disposed on the body, connected to the coil unit, and including a first connection portion covering the first surface of the body and a first pad portion covering the sixth surface of the body, the first pad portion having a smaller width than the first connection portion;
a second external electrode disposed on the body, connected to the coil unit, and including a second connection portion covering the second surface of the body and a second pad portion covering the sixth surface of the body, the second pad portion having a smaller width than the second connection portion; and
an insulating layer covering the first and second connection portions disposed on the first and second surfaces of the body, respectively.

2. The coil component of claim 1, wherein the first and second pad portions are spaced apart from the third and fourth surfaces of the body.

3. The coil component of claim 1, wherein the width of each of the first and second connection portions is a size of each of the first and second connection portions measured in the second direction, and
the width of each of the first and second pad portions is a size of each of the first and second pad portions measured in the second direction.

4. The coil component of claim 2, wherein, based on the second direction, a ratio of a distance by which each of the first and second pad portions is spaced apart from a respective one of the third and fourth surfaces of the body to a width of the body is 0.0167 or more and 0.0833 or less.

5. The coil component of claim 1, wherein the insulating layer extends to cover the third and fourth surfaces of the body.

6. The coil component of claim 5, wherein the insulating layer extends to cover the fifth surface of the body.

7. The coil component of claim 1, wherein the insulating layer extends onto the sixth surface of the body to partially cover the first and second pad portions.

8. The coil component of claim 7, wherein, based on the first direction, a ratio of a length from the third surface or the fourth surface of the body to an end of the insulating layer that extends onto the sixth surface of the body to a length of the body is 0.01 or more and 0.04 or less.

9. The coil component of claim 4, wherein the insulating layer extends onto the sixth surface of the body to partially cover the first and second pad portions.

10. The coil component of claim 9, wherein, based on the first direction, a ratio of a length by which the insulating layer extends onto the sixth surface of the body to a length of the body is 0.01 or more and 0.04 or less.

11. The coil component of claim 1, wherein each of the first and second connection portions and the first and second pad portions includes a first metal layer.

12. The coil component of claim 11, wherein the first metal layer in the first connection portion and the first metal layer in the first pad portion are integrally formed, and
the first metal layer in the second connection portion and the first metal layer in the second pad portion are integrally formed.

13. The coil component of claim 12, wherein each of the first and second pad portions further includes a second metal layer disposed on the first metal layer.

14. The coil component of claim 13, wherein each of the first and second pad portions further includes a third metal layer disposed on the second metal layer.

15. The coil component of claim 1, further comprising a substrate disposed in the body, with the coil unit being disposed on at least one surface thereof.

16. The coil component of claim 1, wherein the coil unit is a wire-wound type coil.

17. A coil component comprising:
a body including a coil unit disposed therein, and having first and second surfaces opposing each other in a first direction with lead-out portions of the coil unit extending thereto, respectively, third and fourth surfaces connected to the first and second surfaces and opposing each other in a second direction, and fifth and sixth surfaces connected to the first to fourth surfaces and opposing each other in a third direction;
a first external electrode disposed on the body, connected to the coil unit, and including a first connection portion covering the first surface of the body and a first pad portion covering the sixth surface of the body;
a second external electrode disposed on the body, connected to the coil unit, and including a second connection portion covering the second surface of the body and a second pad portion covering the sixth surface of the body; and
an insulating layer covering the first and second connection portions disposed on the first and second surfaces of the body, respectively,
wherein the first and second pad portions are spaced apart from the third and fourth surfaces of the body.

18. The coil component of claim 17, wherein the insulating layer extends onto the sixth surface of the body to partially cover the first and second pad portions.

19. The coil component of claim 18, wherein, based on the first direction, a ratio of a length from the third surface or the fourth surface of the body to an end of the insulating layer that extends onto the sixth surface of the body to a length of the body is 0.01 or more and 0.04 or less.

20. The coil component of claim 17, wherein, based on the second direction, a ratio of a distance by which each of the first and second pad portions is spaced apart from a respective one of the third and fourth surfaces of the body to a width of the body is 0.0167 or more and 0.0833 or less.
